(19) United States
(12) Patent Application Publication
(10) Pub. No.: US 2013/0272816 A1
(43) Pub. Date: Oct. 17, 2013

(54) VILAS BOLT, NUT, STUD, SCREW, AND SLEEVE

(71) Applicant: Eduardo Manuel Vilas, Hopewell Junctions, NY (US)

(72) Inventor: Eduardo Manuel Vilas, Hopewell Junctions, NY (US)

(21) Appl. No.: 13/448,388

(22) Filed: Apr. 16, 2012

(51) Int. Cl. F16B 37/14; F16B 33/00

(52) U.S. Cl. 411/429; 411/366.1

(57) ABSTRACT

The present invention relates generally to Vilas bolt, nut, stud, screw, and sleeve. More particularly, the invention encompasses a Vilas screw having a first set of threads at one end, such as, a wood screw type threads, and a second set of threads at the opposite end, such as, a machine screw type threads, and with a flange nut between the two different sets of threads. The present invention is also directed to a Vilas screw having a first set of threads at one end and a second set of threads at the opposite end where the second set of threads are inside a blind hole and with a flange nut on the outer surface of the shaft. The invention also encompasses a Vilas sleeve, a Vilas nut, a Vilas screw, a Vilas stud, a Vilas bolt, and combinations thereof, and wherein each has mating capabilities.

### FIELD OF THE INVENTION

The present invention relates generally to Vilas bolt, nut, stud, screw, and sleeve. More particularly, the invention encompasses a Vilas screw having a first set of threads at one end, such as, a wood screw type threads, and a second set of threads at the opposite end, such as, a machine screw type threads, and with a flange nut between the two different sets of threads. The present invention is also directed to a Vilas screw having a first set of threads at one end and a second set of threads at the opposite end where the second set of threads are inside a blind hole and with a flange nut on the outer surface of the shaft. The invention also encompasses a Vilas sleeve, a Vilas nut, a Vilas screw, a Vilas stud, a Vilas bolt, and combinations thereof, and wherein each has mating capabilities.

### BACKGROUND IN FORMATION

Various efforts have been done in the past to improve the basic design and utility of screws, sleeves and nuts. Similarly, efforts have been made to further the art of screws, sleeves and nuts but they have had limited success.

U.S. Pat. No. 4,199,127 (Richard D. Osborn), the entire disclosure of which is incorporated herein by reference, discloses a security nut and hook assembly compatible with pipe-type car top carriers in order to prevent inadvertent and unauthorized removal of a payload from such a carrier includes a hook-forming element arranged for engaging a rail of the car top carrier. A clamp engages with the hook-forming member for securing a payload to the rail of the carrier, with a retainer attachable to the hook-forming member and the clamp for biasing the clamp against the rail of the carrier while simultaneously retaining the entire assembly on the carrier rail.

U.S. Pat. No. 4,636,125 (Francis A. Burgard), the entire disclosure of which is incorporated herein by reference, discloses a mounting device that has an elongated body having a wood screw on one end and a (machine screw) threaded hole at its other end. The drift pin mounted in the cross bore provides a handle for screwing the body into a tree or post. The body at said other end has a hexagonal exterior enabling use of a wrench to screw the device into the tree. When the device is mounted in a tree an archer can transfer the container of a “trailer” from his bow to the device, thus freeing the archer to do other things while waiting for his prey to die.

U.S. Pat. No. 5,678,703 (Gerald F. Sawyer), the entire disclosure of which is incorporated herein by reference, discloses a large diameter curtain rod that has a small, lamp shade finial fixed to the ends through an adapter. The adapter may have a screw with a wood-screw thread on one end and a machine-screw thread on the other. The wood-screw thread is inserted into the rod, and the finial is screwed onto the machine-screw thread. When the finial thread does not match the screw thread, a bushing is used to adapt the screw thread. An end cap can cover the end of the rod and be held in place by the bushing or the finial. For metal rods, an end cap has a female thread to engage the rod; and, a threaded stud for receiving a finial extends from the end cap.

U.S. Pat. No. 6,467,989 (Michael Finkelstein), the entire disclosure of which is incorporated herein by reference, discloses an adjustable connector that can slide along a rod or tube and can be secured from axially translating in infinite positions along the entire length of the tube. It also has the capability of attaching itself to a surface or structural element such as a shelf.

U.S. Patent Publication No. 2005/0125962 (Steven Hong), the entire disclosure of which is incorporated herein by reference, discloses a locking structure for combing a hook and a hanging ring comprises a hook member, a hanging ring, a screw nut and a spring lock pin. The screw nut having a plurality of radially distributed blocks formed on an upper end thereof. And the spaces between adjacent blocks define a plurality of radially distributed retaining slots. The locking section of the hook member is inserted through the base of the hanging ring and connects the screw nut. The spring lock pin is inserted through the through hole and two opposite retaining slots so as to lock the hook member and the hanging ring together. Thereby, the self-gravity of the hook member can pull the screw nut downward so that the spring lock pin is pressed against the screw nut and thus secured, without the riveting mechanism necessary in conventional locking structures.

None of the above inventions and patents, taken either singly or in combination, is seen to describe the instant invention as claimed.

This invention improves on the deficiencies of the prior art and provides an inventive Vilas bolt, nut, screw, and sleeve.

### PURPOSES AND SUMMARY OF THE INVENTION

The invention comprises of Vilas bolt, Vilas nut, Vilas screw, Vilas stud, Vilas sleeve, and combinations thereof.

Therefore, one purpose of this invention is to provide a cost effective, versatile, and durable bolt, stud, nut, screw, sleeve, and combinations thereof.

Another purpose of this invention is to provide a Vilas screw having a first set of threads at one end, such as, a wood screw type threads, and a second set of threads at the opposite end, such as, a machine screw type threads, and with a flange nut between the two same or different sets of threads.

Yet another purpose of this invention is to provide a Vilas screw having a first set of threads at one end and a second set of threads at the opposite end where the second set of threads are inside a blind hole and with a flange nut on the outer surface of the shaft of the Vilas screw.

Still yet another purpose of this invention is to provide a Vilas sleeve, Vilas nut, Vilas bolt, Vilas screw, Vilas stud, and combinations thereof, and wherein each has mating capabilities.

Therefore, in one aspect this invention comprises a hardware device comprising:

(a) a first shaft, said first shaft having a first set of threads;

(b) a second shaft, said second shaft having a second set of threads; and

(c) at least one nut securely held between said first shaft and said second shaft.

In another aspect this invention comprises a hardware device, comprising a nut having a central opening, and at least one hook, wherein said at least one hook has a first end and a second end, and wherein at least said first end of said at least one hook secured to at least one external surface of said nut.

In yet another aspect this invention comprises a hardware device comprising:

(a) a shaft, said shaft having a first set of threads on an outer surface of said shaft at a first end;

(b) said shaft having a blind hole at a second end, wherein said first end is opposite said second end, and wherein a second set of threads are contained inside said blind hole; and

(c) at least one nut secured to said shaft, and wherein said nut has an upper flat surface, and a lower flat surface, such that said upper flat surface is directly opposite said lower flat surface.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1A, illustrates a cross-sectional side view of a first embodiment of the invention comprising a Vilas screw.

FIG. 1B, illustrates a cross-sectional side view of a first embodiment of the invention comprising a Vilas screw taken along 1B-1B, from FIG. 1A.

FIG. 2A, illustrates a cross-sectional side view of a second embodiment of the invention comprising a Vilas screw.

FIG. 2B, illustrates a cross-sectional side view of a second embodiment of the invention comprising a Vilas screw taken along 2B-2B, from FIG. 2A.

FIG. 3A, illustrates a cross-sectional side view of a third embodiment of the invention comprising a Vilas sleeve.

FIG. 3B, illustrates a cross-sectional side view of a third embodiment of the invention comprising a Vilas sleeve taken along 3B-3B, from FIG. 3A.

FIG. 4A, illustrates a cross-sectional side view of a fourth embodiment of the invention comprising a Vilas sleeve.

FIG. 4B, illustrates a cross-sectional side view of a fourth embodiment of the invention comprising a Vilas sleeve taken along 4B-4B, from FIG. 4A.

FIG. 5A, illustrates a cross-sectional side view of a fifth embodiment of the invention comprising a Vilas sleeve.

FIG. 5B, illustrates a cross-sectional side view of a fifth embodiment of the invention comprising a Vilas sleeve taken along 5B-5B, from FIG. 5A.

FIG. 6, illustrates a cross-sectional side view of a sixth embodiment of the invention comprising a Vilas nut.

FIG. 7, illustrates a cross-sectional side view of a seventh embodiment of the invention comprising a Vilas nut.

FIG. 8, illustrates a cross-sectional side view of an eighth embodiment of the invention comprising a Vilas screw securing a gutter.

FIG. 9, illustrates a cross-sectional side view of a ninth embodiment of the invention comprising a Vilas screw securing a gutter.

FIG. 10, illustrates a cross-sectional side view of a tenth embodiment of the invention comprising a Vilas stud.

### DETAILED DESCRIPTION

The screw name brand will be the Vilas bolt and Vilas nut, and they could be commonly branded as the Vbolt and Vnut, respectively. This Vbolt technology will be a revolution in the building technology, similar to the car technology, as it uses the structure of a building as a frame in a car. When one has a Vbolt or a Vnut in the frame or structure one does not have to perform or replace anything to attach anything to it. For example, one does not have to replace the rotor, hub and bearing, when one changes a tire in a car. The difficulty to replace, for example, a bathroom cabinet, would be the same as changing a tire in a car.

This technology will make kitchen cabinets, bathroom cabinets, store shelves, etc. more economic, as it uses less materials, and it is reusable, because one only has to replace the face of the cabinet, and labor is more economic, because it will take less time to put it together and one does not need be a master carpenter to do it. Any handy person will be able to install and remove or dismantle fixtures that use the Vbolt, Vnut, Vscrew, Vsleeve, technology. In the construction industry they will start using this technology when they use the Vbolt and Vnut in new housing as a standard, to make is ready for the installation of cabinets, doors, sinks, counter tops, windows, gates, fences, light conduits, water and sewer pipes, wiring, etc.

The Vbolt can be used for concrete, wood, and any other materials. For example, in the developing countries were the constructions are made with less expensive materials, they use, mostly concrete, and bricks. Also in developing countries where people do not have the monies, they leave everything on the floor, such as, electric wires, fans, lights, shoes, laundry, bags, books, computers, food, cloth, shampoo, soap, towels, to name a few, as they do not have cabinets and hangers.

It is contemplated that a ⅜ Vilas bolt, or Vilas nut, or Vilas stud, or Vilas sleeve, or Vilas screw, could hold for example, a five hundred pound load. One end of this Vbolt would be attached to the wood, metal, concrete, to name a few, as a wood-type screw, while the opposite end could be attached to a wood, metal, concrete, to name a few, as a machine-type screw.

The Vilas screw, Vilas bolt, Vilas nut, Vilas sleeve, Vilas stud, has many applications, such as, in conjunctions with kitchen cabinets, bedroom cabinets, counter tops, doors, shelves, hinges, bathroom cabinets, curtain rods, cloth hangers, TV roof hangers, flowers pots hangers, sports nets, roof safety anchoring, A/C ducts, pipes, tubes, cables, signs, lights, furniture repairs, drop ceiling hangers, to name a few.

The Vilas screw, Vilas bolt, Vilas nut, Vilas stud, Vilas sleeve, has many other applications, such as, one could use it in conjunctions with framing a wall, using boards as a shelf and then attaching them to a back wall, shelving, securing side panels, securing doors, securing shelving from ceiling to floor, securing pipes and holding them from walls and ceilings, using with duct, securing wires to a wall, using as a drop ceiling, bathroom cabinet, TV hanging from ceiling or walls, securely hanging fans from ceiling or walls, securely hanging plants from ceiling or walls, securing curtain rod from wall to wall or cloth hanger from the side wall, securing a clothing line or cloth rope from one wall to another wall, as a towel hanger, to name a few.

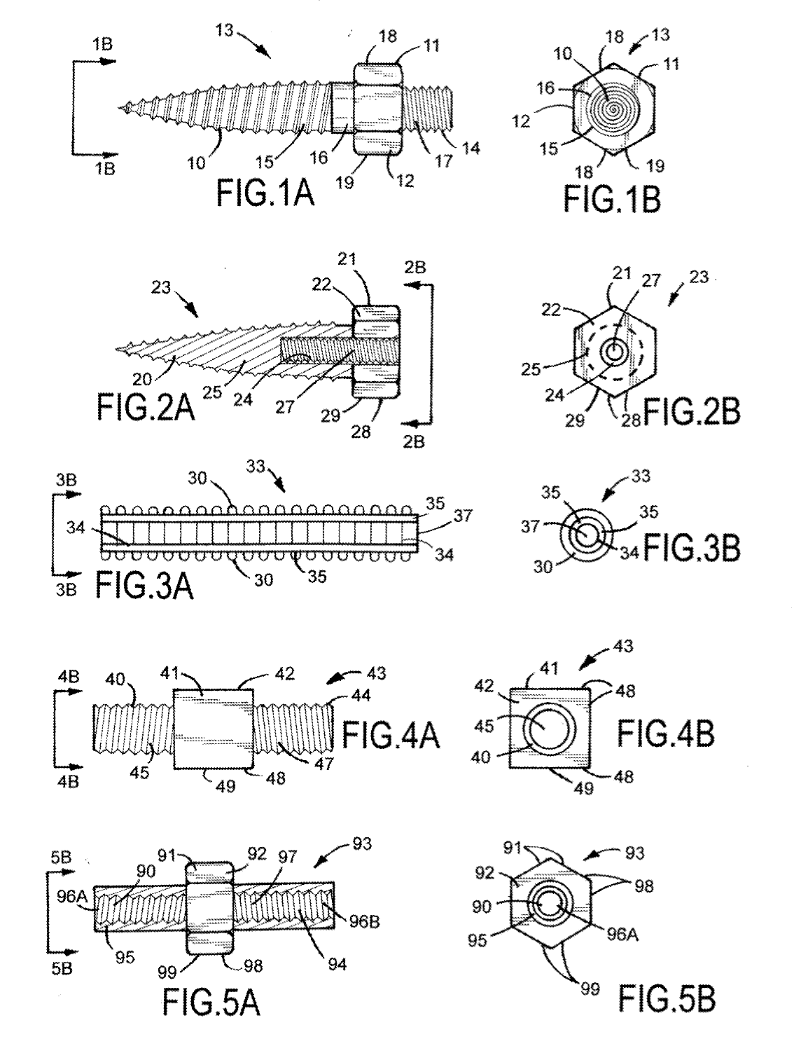

FIG. 1A, illustrates a cross-sectional side view of a first embodiment of the invention comprising a Vilas screw 13, or Vscrew 13, while FIG. 1B, illustrates a cross-sectional side view of the Vilas screw 13, taken along 1B-1B, from FIG. 1A. The Vilas screw 13, comprises of a first shaft 15, having a first set of threads 10, on one side or at one end, and a second shaft 17, having a second set of threads 14, at the second side or at the second end, and wherein the first side or end is opposite the second side or end. Between the first end and the second end the Vilas screw 13, comprises at least one nut 12, such as, a flange nut 12, having at least one first or upper flat surface 11, and at least one second or lower flat surface 19, such that the first flat surface 11, is directly opposite the second flat surface 19. The first end could comprise a screw thread 10, such as, a wood screw 10, while the second end could comprise a screw thread 14, such as, a machine screw 14. The at least two flat surfaces 11, 19, at the flange nut 12, allows a person to use a spanner or wrench or similar such device to securely hold and either tighten or loosen the Vilas screw 13. As shown in FIG. 1A, the flange nut 12, is between a smooth surface or space 16, and the second set of threads 14, however the flange nut 12, can be anywhere along the shaft 15, 17, of the Vilas screw 13, as long as it does not defeat the operation of the first set of threads 10, or the operation of the second set of threads 14. The first set of threads 10, are in a first direction, while the second set of threads 20, are in a second direction, and wherein the first direction and the second direction are in the same direction, or are in an opposite direction, or are in a neutral direction, or are in a direction that is substantially horizontal to a vertical plane. Similarly, the threads 10, 14, could be left threads 10, 14, or right threads 10, 14. For some applications the outer surface of the nut 12, could be substantially flush with the surface 16. Similarly, the outer peripheral surface of the nut 12, could be above or below the outer peripheral surface of the threads 10, 14. The nut 12, has width 18, which width 18, should be sufficiently wide to engageably accommodate a screw rotating device (not shown), such as, a spanner, wrench, to name a few.

FIG. 2A, illustrates a cross-sectional side view of a second embodiment of the invention comprising a Vilas screw 23, or Vscrew 23, while FIG. 2B, illustrates a cross-sectional side view of the Vitas screw 23, taken along 2B-2B, from FIG. 2A. The Vilas screw 23, comprises of a shaft 25, having a first set of threads 20, on one side or at a first end, and a blind hole or opening 27, at the second side or second end, such that the first end and the second end are opposite each other. The blind hole or opening 27, has a second set of threads 24, which are inside the blind hole 27, and form a female portion of the Vilas screw 23, while the first set of threads 20, are on the outside of the shaft 25, and form a male portion of the Vilas screw 23. Between the first end and the second end the Vilas screw 23, comprises at least one nut 22, such as, a flange nut 22, having at least one first or upper flat surface 21, and at least one second or lower flat surface 29, such that the first flat surface 21, is directly opposite the second flat surface 29. The first end could comprise a screw thread 20, such as, a wood screw 20, forming the male portion 20, while the second end could comprise a screw thread 24, such as, a machine screw 24, forming a female portion 24. The at least two flat surfaces 21, 29, at the flange nut 22, allows a person to use a spanner or wrench or similar such device to securely hold and either tighten or loosen the Vilas screw 23. As shown in FIG. 2A, the flange nut 22, is at one end, however the flange nut 22, can be anywhere along the shaft 25, of the Vilas screw 23, as long as it does not defeat the operation of the first set of threads 20. The outer peripheral surface of the nut 22, could be above or below the outer peripheral surface of the threads 20. The nut 22, has width 28, which width 28, should be sufficiently wide to engageably accommodate a screw rotating device (not shown), such as, a spanner, wrench, to name a few.

FIG. 3A, illustrates a cross-sectional side view of a third embodiment of the invention comprising a Vilas sleeve 33, or Vsleeve 33, while FIG. 3B, illustrates a cross-sectional side view of the Vilas sleeve 33, taken along 3B-3B, from FIG. 3A. The Vilas sleeve 33, comprises of a shaft 35, having a first set of threads 30, on the outside or outer surface or at a first surface of the shaft 35, and a second set of threads 34, which are inside a through-hole 37, or blind hole 37, or opening 37, and forms a female portion of the Vilas sleeve 33, while the first set of threads 30, that are on the outside form a male portion of the Vilas screw 33. The first set of threads 30, could comprise a screw 30, such as, a machine screw 30, forming the male portion 30, while the second set of threads 34, could comprise a screw 34, such as, a machine screw 34, forming a female portion 34. It should be appreciated that the first set of threads 30, can be engageably secured to the Vscrew 23, via second sets of threads 24, inside the blind hole 27, where the second set of threads 24, act as a female portion 24, while the first set of threads 30, act as a male portion 30. Similarly, the second set of threads 34, can be engageably secured to the Vscrew 13, via the second sets of threads 14, where the second set of threads 14, act as a male portion 14, while the second set of threads 34, act as a female portion 34.

FIG. 4A, illustrates a cross-sectional side view of a fourth embodiment of the invention comprising a Vilas sleeve 43, or Vsleeve 43, while FIG. 4B, illustrates a cross-sectional side view of the Vilas sleeve 43, taken along 4B-4B, from FIG. 4A. The Vilas sleeve 43, comprises of a first shaft 45, having a first set of threads 40, on the outside or outer surface or at a first surface of the shaft 45, and a second shaft 47, having a second set of threads 44, which are on the outside surface of the second shaft 47, and forms a second male portion of the Vilas sleeve 43, while the first set of threads 40, that are on the outside form a first male portion of the Vilas sleeve 43. The first set of threads 40, could comprise a screw thread 40, such as, a machine screw 40, forming a first male portion 40, while the second set of threads 44, could comprise a screw thread 44, such as, a machine screw 44, forming a second male portion 44. The first set of threads 40, could be in a first direction, while the second set of threads 44, could be along a second direction, wherein, for example, the first direction could be in a clockwise direction, while the second direction, could be for example, in a counterclockwise direction. It should be appreciated that the first set of threads 40, can be engageably secured to the Vscrew 23, via second sets of threads 24, inside the blind hole 27, where the second set of threads 24, act as a female portion 24, while the first set of threads 40, act as a male portion 40. Similarly, the second set of threads 44, can be engageably secured to the Vscrew 23, via the second sets of threads 24, where the second set of threads 24, act as a female portion 24, while the second set of threads 44, act as a male portion 44. And, thus the Vsleeve 43, could have a Vscrew 23, at each end. Between the first end and the second end the Vilas sleeve 43, comprises at least one nut 42, such as, a flange nut 42, having at least one first or upper flat surface 41, and at least one second or lower flat surface 49, such that the first flat surface 41, is directly opposite the second flat surface 49. The at least two flat surfaces 41, 49, at the flange nut 42, allows a person to use a spanner or wrench or similar such device to securely hold and either tighten or loosen the Vilas sleeve 43. The flange nut 42, can be anywhere along the shaft 45, 47, of the Vilas sleeve 43, as long as it does not defeat the operation of the first set of threads 40, or the operation of the second set of threads 44. The outer peripheral surface of the nut 42, could be above or below the outer peripheral surface of the threads 40, 44. The nut 42, has width 48, which width 48, should be sufficiently wide to engageably accommodate a screw rotating device (not shown), such as, a spanner, wrench, to name a few.

FIG. 5A, illustrates a cross-sectional side view of a fifth embodiment of the invention comprising a Vilas sleeve 93, or Vsleeve 93, while FIG. 5B, illustrates a cross-sectional side view of the Vilas sleeve 93, taken along 5B-5B, from FIG. 5A. The Vilas sleeve 93, comprises of a first shaft 95, having a first set of threads 90, on the inside or inner surface or at a first surface of the shaft 95, formed by a first blind opening 96A, or hole 96A, and a second shaft 97, having a second set of threads 94, which are on the inside surface of the second shaft 97, formed by a second blind opening 96B, or hole 96B, and forms a second female portion of the Vilas sleeve 93, while the first set of threads 90, that are on the inside of the first blind hole 96A, form a first female portion of the Vilas sleeve 93. The first set of threads 90, could comprise a screw thread 90, such as, a machine screw 90, forming a first female portion 90, while the second set of threads 94, could comprise a screw thread 94, such as, a machine screw 94, forming a second female portion 94. The first set of threads 90, could be in a first direction, while the second set of threads 94, could be along a second direction, wherein, for example, the first direction could be in a clockwise direction, while the second direction, could be for example, in a counterclockwise direction. It should be appreciated that the first set of threads 90, can be engageably secured to the Vscrew 13, via second sets of threads 14, inside the hole 96A, where the first set of threads 90, act as a female portion 90, while the second set of threads 14, act as a male portion 14. Similarly, the second set of threads 94, can be engageably secured to the Vscrew 13, via the second sets of threads 14, where the second set of threads 94, act as a female portion 94, while the second set of threads 14, act as a male portion 14. Between the first end and the second end the Vilas sleeve 93, comprises at least one nut 92, such as, a flange nut 92, having at least one first or upper flat surface 91, and at least one second or lower flat surface 99, such that the first flat surface 91, is directly opposite the second flat surface 99. The at least two flat surfaces 91, 99, at the flange nut 92, allows a person to use a spanner or wrench or similar such device to securely hold and either tighten or loosen the Vilas sleeve 93. The flange nut 92, can be anywhere along the shaft 95, 97, of the Vilas sleeve 93, as long as it does not defeat the operation of the first set of threads 90, or the operation of the second set of threads 94. The outer peripheral surface of the nut 92, could be above or below the outer peripheral surface of the shaft 95, 97. The nut 92, has width 98, which width 98, should be sufficiently wide to engageably accommodate a screw rotating device (not shown), such as, a spanner, wrench, to name a few.

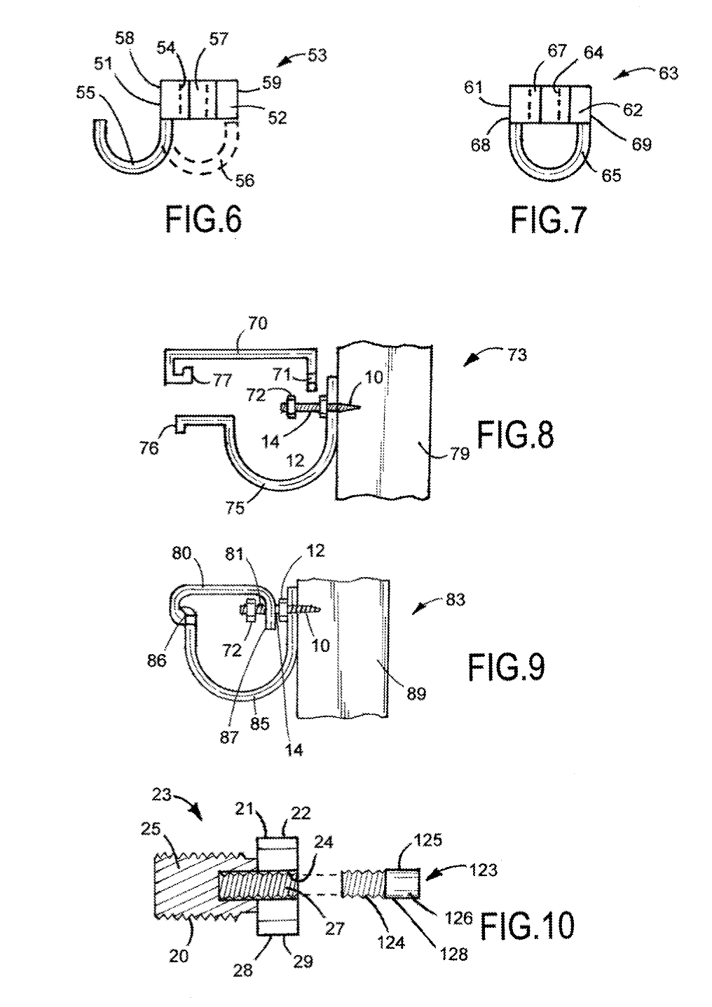

FIG. 6, illustrates a cross-sectional side view of a sixth embodiment of the invention comprising a Vilas nut 53, or Vnut 53. The Vilas nut 53, comprises of a nut 52, such as, a flange nut 52, having a through opening 57, or hole 57, or a blind hole 57, and having a first set of threads 54, inside the hole 57. At least on one of the exterior surfaces of the flange nut 52, there is at least one outwardly facing open hook 55, and/or at least one inwardly facing open hook 56. The flange nut 52, has at least one first or upper flat surface 51, and at least one second or lower flat surface 59, such that the first flat surface 51, is directly opposite the second flat surface 59. The at least two flat surfaces 51, 59, at the flange nut 52, allow a person to use a spanner or wrench or similar such device to securely hold and either tighten or loosen the Vilas nut 53. It should be appreciated that the hole 57, could also be a blind hole 57, as tong as it does not defeat the operation of the Vilas nut 53. The first set of threads 54, are machine screw type threads 54, that can be mated with the second set of threads 14, of the Vscrew 13, and where the first set of threads 54, act as a female portion 54, while the second set of threads 14, act as the male portion 14. The nut 52, has width 58, which width 58, should be sufficiently wide to engageably accommodate a screw rotating device (not shown), such as, a spanner, wrench, to name a few.

FIG. 7, illustrates a cross-sectional side view of a seventh embodiment of the invention comprising a Vilas nut 63, or Vnut 63. The Vilas nut 63, comprises of a nut 62, such as, a flange nut 62, having a through opening 67, or a blind-hole 67, and having a first set of threads 64, inside the hole 67. At least on one of the exterior surfaces of the flange nut 62, there is at least one closed hook 65. The flange nut 62, has at least one first or upper flat surface 61, and at least one second or lower flat surface 69, such that the first flat surface 61, is directly opposite the second flat surface 69. The at least two flat surfaces 61, 69, at the flange nut 62, allow a person to use a spanner or wrench or similar such device to securely hold and either tighten or loosen the Vilas nut 63. It should be appreciated that the hole 67, could also be a blind hole 67, as long as it does not defeat the operation of the Vilas nut 63. The first set of threads 64, are machine screw type threads 64, that can be mated with the second set of threads 14, of the Vscrew 13, and where the first set of threads 64, act as a female portion 64, while the second set of threads 14, act as the male portion 14. The nut 62, has width 68, which width 68, should be sufficiently wide to engageably accommodate a screw rotating device (not shown), such as, a spanner, wrench, to name a few.

FIG. 8, illustrates an application of this invention illustrating a cross-sectional side view of a eighth embodiment of the invention comprising a Vilas screw 13, 23, securing a gutter 73. The gutter 73, comprises of a gutter base or trough or channel portion 75, having an edge or lip or extension 76, and a gutter cover 70, having an edge or lip or extension 77. The gutter 73, is secured to a wall 79, using at least one Vilas screw 13, 23. The gutter cover 70, could have at least one opening or U-shaped slit or hole 71, which would be secured to the shaft 15, 25, of the Vilas screw 13, 23, and secured to the wall 79, using at least one nut 72, or bolt 72. As shown in FIG. 8, the first end 10, 20, having the first threads 10, 20, comprising a wood screw 10, 20, secures the gutter base 75, to the wall 79. The second end 14, 24, having the second threads 14, 24, comprising a machine screw 14, 24, accommodates the hole 71, of the gutter cover 70, and a nut 72, having machine threads 72, is then slid over the shaft 15, 17, 25, or inserted into the blind hole 27, to mate with the second set of threads 24, along the second threaded portion 14, 24, to secure the gutter cover 70, to the gutter base 75. Once the gutter cover 70, is secured to the gutter base 75, the lip 77, and lip 76, can be brought in close contact to each other and can be securely engaged to each other by methods well known in the art.

FIG. 9, illustrates an application of this invention illustrating a cross-sectional side view of an ninth embodiment of the invention comprising a Vilas screw 13, 23, securing a gutter 83. The gutter 83, comprises of a gutter base or trough or channel portion 85, having a gutter cover 80, secured thereto using at least one hinge 86. The gutter cover 80, has an edge or lip or extension 87, having at least one opening or U-shaped slit or hole 81. The gutter base 85, is secured to a wall 89, using at least one Vilas screw 13, 23. The gutter cover 80, could have at least one opening or U-shaped slit or hole 81, which would be secured to the shaft 15, 25, of the Vilas screw 13, 23, and secured to the wall 89, using at least one nut 72. As shown in FIG. 9, the first end 10, 20, having the first threads 10, 20, comprising a wood screw 10, 20, secures the gutter base 85, to the wall 89, while the second end 14, 24, having the second threads 14, 24, comprising a machine screw 14, 24, remain inside the gutter base 85. Once the gutter base 85, has been secured to the wall 89, the edge 87, having the slit 81, of the gutter cover 80, which is hingably secured via hinge 86, to the gutter base 85, is then brought in contact with the shaft 15, 17, 25, and secured thereto by methods well known in the art.

FIG. 10, illustrates a cross-sectional side view of a tenth embodiment of the invention comprising a Vilas stud 123, or Vstud 123. The Vilas stud 123, comprises of a shaft 125, having at least a portion having a first set of threads 124, and at least a portion having a plain engaging surface 126. The plain engaging surface 126, could have a cross-sectional area 126, selected from a group comprising, triangular, circular, elliptical, rectangular, square, polygonal, to name a few. The plain engaging surface 126, could also have a width 128, which width 128, should be sufficiently wide to engageably accommodate a screw rotating device (not shown), such as, a spanner, wrench, to name a few. As one can appreciate that the Vstud 123, can be screwed into the blind hole 27, so that the threads 24, securely engage with threads 124, and secure the Vstud 123, to the Vscrew 23. Similarly, the Vstud 123, can be securely engaged with one or both sides of the Vsleeve 33, 93. The Vstud 123, can also securely engage and mate with the Vnut 53, 63.

The Vilas screw 13, 23, Vitas sleeve 33, 43, 93, Vilas nut 53, 63, Vilas stud 123, could be made from a material selected from a group comprising, stainless steel, galvanized steel, copper, bronze, brass, plastic, metal, composite material, metallic composite material, to name a few.

It should be appreciated that the outer shape for the flange nut 12, 22, 42, 52, 62, 92, having the flat surfaces 11, 19, 21, 29, 41, 49, 51, 59, 61, 69, 91, 99, could be selected from a group comprising of a rectangular shape, a triangular shape, a polygonal shape, just to name a few.

The shape of the flat surface 11, 19, 21, 29, 41, 49, 51, 59, 61, 69, 91, 99, could be selected from a group comprising of a rectangular shape, a triangular shape, a polygonal shape, just to name a few.

The flange nut 12, 22, 42, 52, 62, 92, have a width 18, 28, 48, 58, 68, 98, respectively, and wherein the width 18, 28, 48, 58, 68, 98, is between about ⅛th inch to about 1 inch, however the width 18, 28, 48, 58, 68, 98, could be selected from a group comprising about ⅛th inch, about ¼ inch, about ⅓ inch, about ½ inch, about ⅔ inch, about ¾ inch, and about 1 inch.

The average cross-sectional area, radius, diameter, circumference, peripheral area of the shaft 15, 17, 45, 47, 95, 97, could be the same or could be different.

It should be understood that the threads can be left threads, right threads, machine threads, wood thread, or some other similar types of threads which are well known in the hardware arts.

For some applications the width 28, of flange nut 22, at the end of the threaded part of the screw 23, should be as thin as possible. However, this would also depend on the thickness of the screw. For example, if hanging a kitchen cabinet the width of the nut should not be thicker than, for example, the sheet rock, so that it will be flush with the wall 79, 89, or if it is a light switch cover, then it should be thin enough so that the cover will be flush with the wall 79, 89.

With this invention it makes it easier to install kitchen cabinets, water heaters, or other heavy things. One would just have to preinstall the Vscrew, Vsleeve, Vbolt, Vnut, Vstud, and then one would lift the load and place it on the Vscrew, Vsleeve, Vbolt, Vnut, Vstud, and then bolt it on, similar to installing a tire on a car.

This invention has many applications, such as, for example, hanging pipes, drop ceilings. When using the threaded sleeve with a half left tread and an half right thread with a flange nut in the middle, one would be able to adjust as desired using a wrench. Because each of the threads are in the opposite direction then while is being loosed the other side would automatically be moving in the opposite direction. For heavy loads it will be without the thread inside or outside depending on the use.

The Vilas invention is hardware, made to be used, as such, for general purposes, and for the general public, and not for a specific one. The nut, screw, sleeves, bolt, stud, they all could be made in all the sizes, and materials imaginable or are well known in the art.

With this hardware to make kitchen cabinets one would make an outer frame, like a picture frame, then one would install the standard doors one has purchased, the shelving can be installed it the same manner as one installs the frame, using the structure of the house as the structure of the cabinet. Standard doors that will not fit perfectly in every situation, but if it is not possible to put more doors, then one could fill the gap with a matching panel. When one has to replace a cabinet one only would have to replace the door. This process can be repeated for other projects, for example, under sink cabinets, bedroom closets, shower doors, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A hardware device comprising:
(a) a first shaft, said first shaft having a first set of threads;
(b) a second shaft, said second shaft having a second set of threads; and
(c) at least one nut securely held between said first shaft and said second shaft.

2. The hardware device of claim 1, wherein said first set of threads are in a first direction.

3. The hardware device of claim 1, wherein said second set of threads are in a second direction.

4. The hardware device of claim 1, wherein said first set of threads are in a first direction, and said second set of threads are in a second direction.

5. The hardware device of claim 1, wherein said first set of threads are in a first direction, and said second set of threads are in a second direction, and wherein said first direction is selected from a group consisting of clockwise direction, counterclockwise direction, left thread direction, right thread direction, and wherein said second direction is selected from a group consisting of clockwise direction, counterclockwise direction, left thread direction, and right thread direction.

6. The hardware device of claim 1, wherein said first shaft has a blind hole to accommodate said first set of threads.

7. The hardware device of claim 1, wherein said first shaft has a blind hole to accommodate said first set of threads, and wherein a stud having a second set of threads is securely operationally engaged to the inside surface of said blind hole to engageably mate with said first set of threads.

8. The hardware device of claim 1, wherein said second shaft has a blind hole to accommodate said second set of threads.

9. The hardware device of claim 1, wherein said first shaft has a blind hole to accommodate said first set of threads, and wherein direction for said first set of threads is selected from a group consisting of clockwise direction, and counterclockwise direction.

10. The hardware device of claim 1, wherein said first shaft has a blind hole to accommodate said first set of threads, and said second shaft has a blind hole to accommodate said second set of threads, and wherein the direction of said first set of threads is selected from a group consisting of clockwise direction, counterclockwise direction, and wherein the direction of said second set of threads is selected from a group consisting of clockwise direction, and counterclockwise direction.

11. The hardware device of claim 1, wherein the material for said hardware is selected from a group consisting of stainless steel, galvanized steel, copper, bronze, brass, plastic, metal, composite material, metallic composite material, and combinations thereof.

12. The hardware device of claim 1, wherein the outer shape of the nut is selected from a group consisting of a rectangular shape, a triangular shape, and a polygonal shape.

13. The hardware device of claim 1, wherein the width of the nut is between about ⅛th inch to about 1 inch.

14. The hardware device of claim 1, wherein the width of the nut is selected from a group consisting of about ⅛th inch, about ¼ inch, about ⅓ inch, about ½ inch, about ⅔ inch, about ¾ inch, and about 1 inch.

15. The hardware device of claim 1, wherein said first set of threads are selected from a group consisting of a wood screw, and a machine screw, and said second set of threads are selected from a group consisting of a wood screw, and a machine screw.

16. A hardware device, comprising a nut having a central opening, and at least one hook, wherein said at least one hook has a first end and a second end, and wherein at least said first end of said at least one hook secured to at least one external surface of said nut.

17. The hardware device of claim 16, wherein said second end of said at least one first hook secured to at least one external surface of said nut.

18. The hardware device of claim 16, wherein said at least one first hook secured to at least one external surface of said nut is selected from a group consisting of an inwardly facing hook, and an outwardly facing hook.

19. A hardware device comprising:
(a) a shaft, said shaft having a first set of threads on an outer surface of said shaft at a first end;
(b) said shaft having a blind hole at a second end, wherein said first end is opposite said second end, and wherein a second set of threads are contained inside said blind hole; and
(c) at least one nut secured to said shaft, and wherein said nut has an upper flat surface, and a lower flat surface, such that said upper flat surface is directly opposite said lower flat surface.
